(19) United States
(12) Patent Application Publication
(10) Pub. No.: US 2022/0107812 A1
(43) Pub. Date: Apr. 7, 2022

(54) HIGHLY PARALLEL PROCESSING ARCHITECTURE USING DUAL BRANCH EXECUTION

(71) Applicant: Ascenium, Inc., Campbell, CA (US)

(72) Inventor: Peter Foley, Los Altos Hills, CA (US)

(73) Assignee: Ascenium, Inc., Campbell, CA (US)

(21) Appl. No.: 17/551,276

(22) Filed: Dec. 15, 2021

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 9/38; G06F 9/30; G06F 7/575; G06N 3/04

(52) U.S. Cl. CPC G06F 9/3846; G06N 3/04; G06F 7/575; G06F 9/30058

(57) ABSTRACT

Techniques for task processing in a highly parallel processing architecture using dual branch execution are disclosed. A two-dimensional array of compute elements is accessed. Each compute element within the array is known to a compiler and is coupled to its neighboring compute elements within the array of compute elements. Control for the array of compute elements is provided on a cycle-by-cycle basis. The control is enabled by a stream of wide, variable length, control words generated by the compiler. The control includes a branch. Two sides of the branch in the array are executed while waiting for a branch decision to be acted upon by control logic. The branch decision is based on computation results in the array. Data produced by a taken branch path is promoted. Results from a side of the branch not indicated by the branch decision are ignored or invalidated.

### RELATED APPLICATIONS

This application claims the benefit of U.S. provisional patent applications “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to task processing and more particularly to a highly parallel processing architecture using dual branch execution.

### BACKGROUND

As a matter of course, organizations execute processing jobs including accounting, payroll, inventory, and data analysis. The organizations can range in size from “mom and pop” and other small or local ones to large international enterprises. These organizations include charitable groups, financial institutions, governments, hospitals, manufacturers, research laboratories, retail establishments, universities, and many others. Irrespective of the size and the mission of an organization, the processing jobs that are performed process data that is critical to their operation. The collections of data or “datasets” are typically vast. These datasets can include bank or broker account information, trade and manufacturing process secrets, citizenship and tax records, medical records, academic records of grades and degrees, research data, and sales figures, among other data. Addresses, ages, names, email addresses, telephone numbers, and other identifying information are also commonly included. The sizes of the datasets render them difficult to manage, and the processing of the datasets can be computationally complex. The data can also include inaccuracies such as blank data fields or data entered in the wrong field; misspelled names; and inconsistently applied abbreviations or shorthand notations, among others. Effective processing of the data is critical, irrespective of dataset contents.

An organization succeeds or fails based on its abilities to successfully manage data and execute data processing tasks. Additionally, the processing of the data must be performed in a manner that directly benefits the organization. Depending on the organization, direct benefits of the data processing are competitive and financial gain, successful grant application funding, or larger student applicant pools. When the data processing objectives are successfully met, then the organization thrives. If the organizational objectives remain unmet, then unwelcomed and likely disastrous outcomes can be expected. Trends hidden within the data must be identified and tracked, while data anomalies must be uncovered and noted. Trends that are identified and anomalies that can be monetized can provide a differentiating and competitive advantage to the organization.

The techniques used to collect, aggregate, and correlate data from a wide and disparate range of individuals are multifarious. Willing individuals from whom the data is collected include citizens, customers, online shoppers, patients, purchasers, students, test subjects, and volunteers, among many others. At other times however, data is collected from unwitting individuals. Techniques commonly used for data collection include “opt-in” schemes, where an individual creates an account, registers, signs up, or otherwise actively agrees to participate in the data collection. Other techniques are legislative, such as a government requiring citizens to obtain a registration number and to use that number for all interactions with government agencies, emergency services, law enforcement, and others. Further data collection techniques are more subtle or completely hidden, such as network traffic harvesting, purchase history tracking, website visits, button clicks, and menu choices. The collected data is valuable to the organizations, irrespective of the techniques used for the data collection. Rapid processing of these large datasets is critical. The rapid processing of these large datasets is a difficult challenge.

### SUMMARY

Organizations perform a large number of data processing jobs. The job processing, whether for running payroll, analyzing research data, or training a neural network for machine learning, is composed of many complex tasks. The tasks can include loading and storing datasets, accessing processing components and systems, and so on. The tasks themselves can be based on subtasks, where the subtasks can be used to handle loading or reading data from storage, performing computations on the data, storing or writing the data back to storage, handling inter-subtask communication such as data and control, etc. The accessed datasets are often immense, and can easily strain processing architectures that are either ill-suited to the processing tasks or inflexible in their architectures. To greatly improve task processing efficiency and throughput, two-dimensional (2D) arrays of elements can be used for the task and subtask processing. The arrays include 2D arrays of compute elements, multiplier elements, caches, queues, controllers, decompressors, arithmetic logic units (ALUs), and other components. These arrays are configured and operated by providing control to the array on a cycle-by-cycle basis. The control of the 2D array is accomplished by providing control words generated by a compiler. The control includes a stream of control words, where the control words can include wide, variable length, microcode control words generated by a compiler. The control words are used to process the tasks. Further, the arrays can be configured in a topology which is best suited for the task processing. The topologies into which the arrays can be configured include a systolic, a vector, a cyclic, a spatial, a streaming, or a Very Long Instruction Word (VLIW) topology. The topologies can include a topology that enables machine learning functionality.

Task processing is based on a highly parallel processing architecture using dual branch execution. A processor-implemented method for task processing is disclosed comprising: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide, variable length, control words generated by the compiler, and wherein the control includes a branch; executing two sides of the branch in the array while waiting for a branch decision to be acted upon by control logic, wherein the branch decision is based on computation results in the array; and promoting data produced by a taken branch path, based on the branch decision.

Embodiments include using the data that was promoted for a downstream operation. The downstream operation can include an arithmetic, vector, matrix, or tensor operation, a Boolean operation, and so on. The downstream operation can include an operation within a directed acyclic graph (DAG). The promoting the data produced by the taken branch path can be based on scheduling a committed write, by the compiler, to occur outside a branch indecision window. Other embodiments include ignoring results from a side of the branch not indicated by the branch decision. The ignoring the data requires no processing cycles when compared to flushing or clearing the data associated with the not taken branch. Further embodiments include removing results from a side of the branch not indicated by the branch decision. The removing the results can be performed to eliminate race conditions, to avoid data ambiguities, etc. The decisions to promote taken branch path data and to ignore not taken branch data are based on the branch decision. Thus, data produced from either branch path cannot be considered valid until the branch decision is performed.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for a highly parallel processing architecture using dual branch execution.

FIG. 2 is a flow diagram for promoted data use.

FIG. 3 shows a system block diagram for compiler interactions.

FIG. 4A illustrates a system block diagram for a highly parallel architecture with a shallow pipeline.

FIG. 4B illustrates compute element array detail.

FIG. 5 shows a standard code generation pipeline.

FIG. 6 illustrates translating directions to directed acyclic graph (DAG) of operations.

FIG. 7 is a flow diagram for creating a SAT model.

FIG. 8 is a table showing example decompressed control word fields.

FIG. 9 shows a taken branch based on compiler guidance.

FIG. 10 is a system diagram for task processing using a highly parallel architecture.

### DETAILED DESCRIPTION

Techniques for data manipulation based on a highly parallel processing architecture using dual branch execution are disclosed. The tasks that are processed can perform a variety of operations including arithmetic operations, shift operations, logical operations including Boolean operations, vector or matrix operations, tensor operations, and the like. The tasks can include a plurality of subtasks. The subtasks can be processed based on precedence, priority, coding order, amount of parallelization, data flow, data availability, compute element availability, communication channel availability, and so on. The data manipulations are performed on a two-dimensional array of compute elements. The compute elements can include central processing units (CPUs), graphics processing units (GPUs), application specific integrated circuits (ASICs), field programmable gate arrays (FPGAs), cores, and other processing components. The compute elements can include heterogeneous processors, processor cores within an integrated circuit or chip, etc. The compute elements can be coupled to local storage, which can include local memory elements, register files, cache storage, etc. The cache, which can include a hierarchical cache, can be used for storing data such as intermediate results, relevant portions of a control word, and the like. The cache can store promoted data produced by a taken branch path, where the taken branch path is determined by a branch decision. The decompressed control word is used to control one or more compute elements within the array of compute elements.

Multiple layers of the two-dimensional (2D) array of compute elements can be “stacked” to comprise a three-dimensional (3D) array of compute elements. Similar to the compute elements within the 2D array if compute elements, each compute element within the 3D array of compute elements is known to a compiler and is coupled to its neighboring compute elements within the array of compute elements. The stacking can comprise physically stacking discrete chips together in an interconnected stack, or a “logical” 3D stack within a single physical chip, or a combination of both. Some embodiments comprise stacking the 2D array of compute elements with another 2D array of compute elements to form a three-dimensional stack of compute elements. Further dimensions of array stacking are possible. The tasks, subtasks, etc., are generated by a complier. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where the control words are provided on a cycle-by-cycle basis. The one or more control words are generated by the compiler. The control words can include wide, variable length, microcode control words. The length of a microcode control word can be adjusted by compressing the control word, by recognizing that a compute element is unneeded by a task so that control bits within that control word are not required for that compute element, etc. The control words can be used to route data, to set up operations to be performed by the compute elements, to idle individual compute elements or rows and/or columns of compute elements, etc. The compiled microcode control words associated with the compute elements are distributed to the compute elements. The compute elements are controlled by a control unit which operates on decompressed control words. The control words enable processing by the compute elements. The task processing is enabled by executing the one or more control words. In order to accelerate the execution of tasks, the executing can include enabling simultaneous execution of two or more potential compiled task outcomes or sides. In a usage example, a task can include a control word containing a branch. Since the outcome of the branch may not be known a priori to execution of the control word containing a branch decision computation, then all possible control sequences associated with sides of the branch can be executed simultaneously or “pre-executed” using available parallel resources in the array. Thus, when the control word comprising the branch decision computation is executed, the correct sequence of computations comprising the taken branch path can be used, and the incorrect sequences of computations (e.g., the path not taken by the branch) can be ignored and/or removed.

A highly parallel architecture that uses dual branch execution enables task processing. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA), and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. The control is provided to the hardware via one or more control words generated by the compiler. The control can be provided on a cycle-by-cycle basis. The cycle can include a clock cycle, a data cycle, a processing cycle, a physical cycle, an architectural cycle, etc. The control is enabled by a stream of wide, variable length, microcode control words generated by the compiler. The microcode control word lengths can vary based on the type of control, compression, simplification such as identifying that a compute element is unneeded, etc. The control words, which can include compressed control words, can be decoded and provided to a control unit which controls the array of compute elements. The control word can be decompressed to a level of fine control granularity, where each compute element (whether an integer compute element, floating point compute element, address generation compute element, write buffer element, read buffer element, etc.), is individually and uniquely controlled. Each compressed control word is decompressed to allow control on a per element basis. The decoding can be dependent on whether a given compute element is needed for processing a task or subtask; whether the compute element has a specific control word associated with it or the compute element receives a repeated control word (e.g., a control word used for two or more compute elements), and the like. A compiled task is executed on the array of compute elements, based on the set of directions. The execution can be accomplished by executing a plurality of subtasks associated with the compiled task.

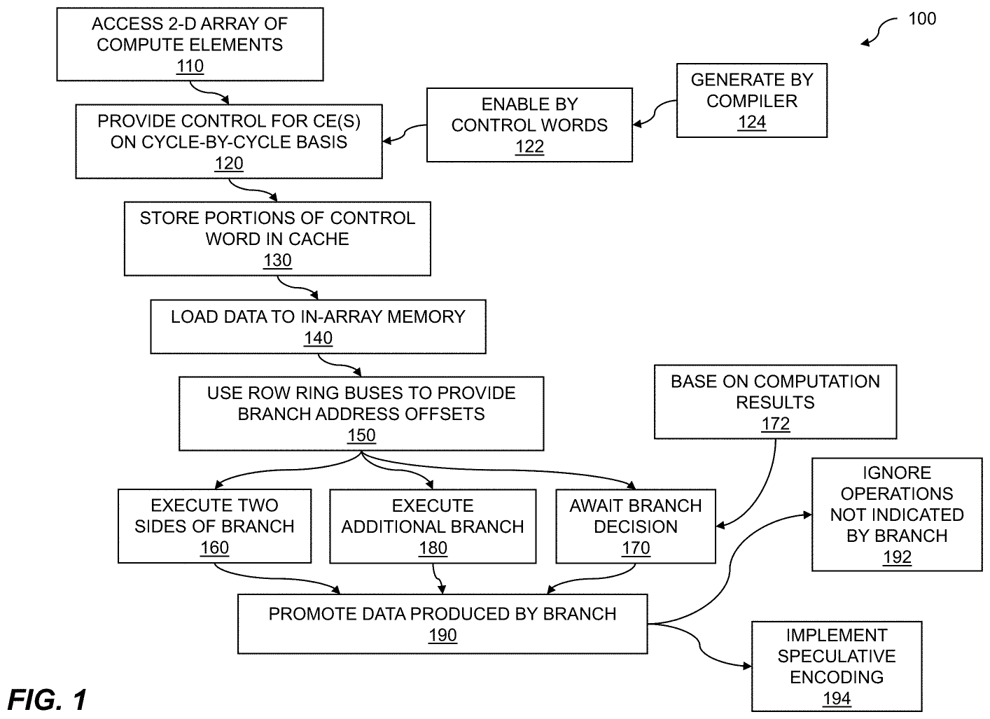

FIG. 1 is a flow diagram for a highly parallel processing architecture using dual branch execution. Clusters of compute elements (CEs), such as CEs assembled within a 2D array of CEs, can be configured to process a variety of tasks and subtasks associated with the tasks. The 2D array can further include other elements such as controllers, storage elements, ALUs, and so on. The tasks can accomplish a variety of processing objectives such as application processing, data manipulation, and so on. The tasks can operate on a variety of data types including integer, real, and character data types; vectors and matrices; tensors; etc. Control to the array of compute elements is provided on a cycle-by-cycle basis, where the control is based on control words generated by a compiler. The control words, which can include microcode control words, enable or idle various compute elements; provide data; route results between or among CEs, caches, and storage; and the like. The control enables compute element operation, memory access precedence, etc. Compute element operation and memory access precedence enable the hardware to properly sequence compute element results. The control enables execution of a compiled task on the array of compute elements. Further, two sides of a branch are executed in the array while waiting for a branch decision to be acted upon by control logic. When the branch decision is made, the data produced by the taken branch patch is promoted, while the data produced by the side of the branch not indicated by the branch decision is ignored.

The flow 100 includes accessing a two-dimensional (2D) array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can include heterogeneous compute resources, where the heterogeneous compute resources may or may not be collocated within a single integrated circuit or chip. The compute elements can be configured in a topology, where the topology can be built into the array, programmed or configured within the array, etc. In embodiments, the array of compute elements is configured by the control word to implement one or more of a systolic, a vector, a cyclic, a spatial, a streaming, a Multiple Instruction Multiple Data (MIMD), or a Very Long Instruction Word (VLIW) topology.

The compute elements can further include a topology suited to machine learning computation. The compute elements can be coupled to other elements within the array of CEs. In embodiments, the coupling of the compute elements can enable one or more topologies. The other elements to which the CEs can be coupled can include storage elements such as one or more levels of cache storage; multiplier units; address generator units for generating load (LD) and store (ST) addresses; queues; and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multiplier elements, ALU elements, or control elements; communication between or among neighboring CEs; and the like.

The flow 100 includes providing control 120 for the array of compute elements on a cycle-by-cycle basis. The control for the array can include configuration of elements such as compute elements within the array loading and storing data; routing data to, from, and among compute elements; and so on. In the flow 100, the control is enabled 122 by a stream of wide, variable length, control words. The control words can configure the compute elements and other elements within the array; enable or disable individual compute elements, rows and/or columns of compute elements; load and store data; route data to, from, and among compute elements; and so on. The one or more control words are generated 124 by the compiler. The compiler which generates the control words can include a general-purpose compiler such as a C, C++, or Python compiler; a hardware description language compiler such as a VHDL or Verilog compiler; a compiler written for the array of compute elements; and the like. The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data, nor is a control word required by it. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task.

The control words that are generated by the compiler can include a conditionality. In embodiments, the control includes a branch. Code, which can include code associated with an application such as image processing, audio processing, and so on, can include conditions which can cause execution of a sequence of code to transfer to a different sequence of code. The conditionality can be based on evaluating an expression such as a Boolean or arithmetic expression. In embodiments, the conditionality can determine code jumps. The code jumps can include conditional jumps as just described or unconditional jumps such as a jump to halt, exit, or terminate instruction. The conditionality can be determined within the array of elements. In embodiments, the conditionality is established by the branch decision operation performed in the array as directed by the control word. The control words can be a decompressed by a decompressor logic block that decompresses words from a compressed control word cache on their way to the array. In embodiments, the set of directions can include a spatial allocation of subtasks on one or more compute elements within the array of compute elements. In other embodiments, the set of directions can enable multiple programming loop instances circulating within the array of compute elements. The multiple programming loop instances can include multiple instances of the same programming loop, multiple programming loops, etc.

The flow 100 further includes storing relevant portions of a control word from the stream of control words within a cache 130 associated with the array of compute elements. The control word stored in the cache can include a compressed control word, a decompressed control word, and so on. Discussed below, an access queue can be associated with the cache, where the access queues can be used to queue requests to access caches, storage, and so on. Data caches can be distinct from control word caches, and the data caches can used for storing data and loading data. The data cache can include a multilevel cache such as a level 1 (L1) cache, a level 2 (L2) cache, and so on. The L1 caches can be used to store blocks of data to be processed. The L1 cache can include a small, fast memory that is quickly accessible by the compute elements and other components. The L2 caches can include larger, slower storage in comparison to the L1 caches. The L2 caches can store “next up” data, results such as intermediate results, and so on. In embodiments, the L1 and L2 caches can further be coupled to level 3 (L3) cache. The L3 caches can be larger than the L2 and L1 caches and can include slower storage. Accessing data from L3 caches is still faster than accessing main storage. In embodiments, the L1, L2, and L3 caches can include 4-way set associative caches. In embodiments, the cache can include a dual read, single write (2R1 W) data cache. As the name implies, a 2R1 W data cache can support up to two read operations and one write operation simultaneously without causing read/write conflicts, race conditions, data corruption, and the like. In embodiments, the 2R1 W cache can support simultaneous fetch of potential branch paths for the compiler. Recall that a branch condition can control two or more branch paths, that is, the branch path taken and the other branch paths not taken are determined by a branch decision.

The flow 100 includes loading data 140 into in-array compute element memory. The data can include integer, real (e.g., floating point), or character data; vector, matrix, or array data; tensor data; etc. The data can be associated with a type of processing application such as image data for image processing, audio data for audio processing, etc. The loading data can be accomplished by loading data from a register file, from a cache, from storage internal to the array, from external storage coupled to the array, and so on. Discussed below, the data can include data generated by sides of a branch, where the branch path can be executed in the array. In embodiments, the loading of data can occur before the branch decision is made. Since the data can be loaded before the branch decision is made, some of the data can be promoted for use by a downstream operation, while other data can be ignored. The flow 100 includes using row ring buses 150 to provide branch address offsets to the array of compute elements. The branch offsets can include unequal offsets, where the unequal offsets are used for the different possible branch paths. The branch offsets can simplify addressing of data in storage by reducing the size of an address used for access to the storage. In a usage example, an offset address that indicates the first storage location for relevant data can be provided. The first datum can be located at the offset address, the second datum at the offset address +1, the third datum at the offset address +2, and so on.

The flow 100 includes executing two sides 160 of the branch in the array. Discussed previously, control words provided to the array of compute elements can include a conditionality, where the conditionality causes a branch in the control. The control word can cause elements in the array to perform a computation that decides the condition—which is then sent to the control logic to change the flow of program control. Since the direction, side, or branch path taken is not known prior to a control unit performing a branch decision, then the two sides of the branch can each be executed. The decision data for the branch decision can be provided by a compute element in the array, unless the branch is an unconditional flow control change, i.e., an unconditional branch. Since any element in the array can provide branch decision data, the control word selects which compute element is the source of the decision data to be used by the control logic. In embodiments, a branch decision can come from a neighboring compute element block, such as a block of four neighboring compute elements, which can reduce the branch decision signal fan-in to the compute element.

For example, execution of one sequence of control words would result from taking one branch path, while execution of another sequence of control words would result from taking the other branch path. Since the correct path is not known a priori, then execution occurs on both paths. The flow 100 includes waiting for a branch decision 170 to be delivered to the control logic. The waiting for the branch decision can be based on a number of cycles, architectural cycles, and so on. The waiting can be based on a number of control words provided before a control word associated with a branch. In the flow 100, the branch decision is based on computation results 172 in the array. The computation results can be based on an arithmetic or Boolean operation, a matrix or tensor operation, and the like. The flow 100 further includes executing an additional branch 180 concurrently with the two sides of a branch. The additional branch can be based on a computation, an evaluation, and so on. In embodiments, the additional branch and the two sides of a branch can include a multiway branch evaluation. In a usage example, a variable A can be compared to a second variable B. A first path can be taken if A<B; a second path can be taken if A+B; a third path can be taken if A>B; etc. The multiway branch evaluation can include a control word such as a switch operation. In other embodiments, the additional branch and the two sides of a branch can include two independent branch decisions. In a usage example, the additional branch can be used to handle an error, an exception, a default, an exit, etc.

The flow 100 includes promoting data 190 produced by a taken branch path, based on the branch decision. With the branch decision made, the correct branch path can be taken, and the associated data promoted. The promoting the data produced by the taken path can include writing the data to a register file, to the cache, to storage internal to the array, to storage external to the array, and so on. It is important to note that the promoting data can only occur following the branch decision. Attempting to promote the data prior to the branch decision can result in incomplete or erroneous data. The promoted data can be used as an input to one or more other compute elements. In embodiments, the data that was promoted can be used for a downstream operation. Various techniques can be used to communicate the branch condition. In embodiments, the branch decision can be communicated using a carry out bit of array Arithmetic Logic Units (ALUs). The branch decision can be communicated using a flag or some other indicator. In other embodiments, the executing can obviate branch prediction logic. Branch prediction attempts to predict which side of a branch will be taken based on code analysis, historical data associated with executing instructions, and so on. The need for branch prediction is obviated by executing the various sides of the branch prior to the branch decision becoming known to a control unit, then selecting the correct branch path based on the branch decision. The flow 100 includes ignoring operations from a side of the branch not indicated by the branch decision 192. The ignoring the operations can include simply leaving results associated with the side of the branch not taken in a register file, cache, storage, etc. If ignoring the unneeded results might cause a race condition or a potential data conflict, then other techniques can be applied to handling the unneeded data. Other embodiments can include removing results from a side of the branch not indicated by the branch decision. The removing can include overwriting the data, deleting the data, and the like. Further embodiments can include ignoring data that was loaded into the in-array compute element memory, based on the branch decision. The in-array compute element memory can be made available for storage of other data. In general, the “side effects” of the data from a branch not taken can be ignored, as long as they do not overwrite data in the array that is needed later by the taken branch path, or they do not store data from the untaken path that is committed to the memory system from the array.

In some embodiments, certain operations are performed in the array for two or more sides of a branch instruction. The results of the branch path or paths that are not taken can be ignored, and any side effects of the branch path or paths not taken can be cleared. However, minimizing the number of speculatively performed operations can both minimize the side effects to be cleared or ignored and reduce power consumption in the array. To achieve this, the compiler can implement speculative encoding 194, where a control word can be speculatively encoded such that the encoding can span one or more “basic blocks” implemented in the array, which can include temporal spanning of a branch operation. Basic blocks can be those contiguous groups of instructions that occur between branches in the code. Because the array of compute elements can provide a large resource facility, a compressed control word (CCW) can speculatively encode a large number of parallel operations, which operations can encompass multiple branch paths.

As a branch decision is made, say, through an arithmetic operation comparing two values, branch control logic can be quickly made aware of the branch decision results. The branch control logic can then suppress the actual computation for operations in the array that need not be completed. In other words, the hardware can convert any control words for those operations that need not be completed (suppressed operations) into an idle command for the affected compute elements. In fact, if the particular compute element has not yet started processing the operation, an operation control start may be withheld from that compute element, that is, it is never driven into the array.

To support this approach, the compiler would schedule and reserve in the array all the resources needed to support any potential computation path affected by the branch. Thus, rather than speculatively executing a path with potential early termination, where instruction execution is terminated somewhere in an execution pipeline, the disclosed invention can implement speculative encoding of control words with early suppression, where operation control for a particular compute element or elements for a given cycle is not driven into the array.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

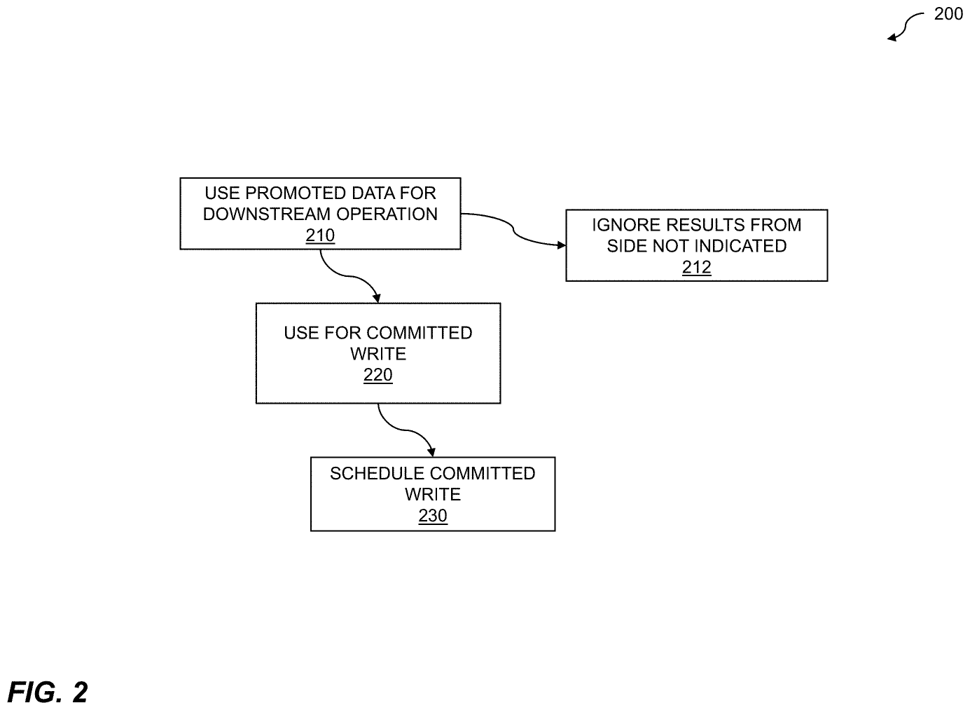

FIG. 2 is a flow diagram for promoted data use. Discussed throughout, tasks, subtasks, and the like, can be processed on an array of compute elements. A task can include general operations such as arithmetic, vector, array, or matrix operations; Boolean operations such as NAND, NOR, XOR, or NOT; operations based on applications such as neural network or deep learning operations; and so on. In order for the tasks to be processed correctly, control words are provided on a cycle-by-cycle basis to the array of compute elements. The control words configure the array to execute tasks. The control words can be provided to the array of compute elements by a compiler. The providing control words that control placement, scheduling, data transfers, and so on, within the array, can maximize task processing throughput. This maximization ensures that a task that generates data required by a second task is processed prior to the processing of the second task, and so on. In embodiments, tasks can include branch operations. A branch operation can be based on a conditionality, where a conditionality can be established by a control unit. A branch can include a plurality of “ways”, “paths”, or “sides” that can be taken based on the conditionality. The conditionality can include evaluating an expression such as an arithmetic or Boolean expression, transferring from a sequence of instructions to a second sequence of instructions, and so on. In embodiments, the conditionality can determine code jumps. Since the branch path that will be taken is not known a priori to evaluating the conditionality, each path can be executed. When the conditionality is determined, then data associated with the taken path can be promoted, while data associated with the untaken path can be ignored. Promoted data usage enables a highly parallel processing architecture using dual branch execution. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, control words generated by the compiler, and wherein the control includes a branch. Two sides of the branch are executed in the array while waiting for a branch decision to be acted upon by control logic, wherein the branch decision is based on computation results in the array. Data produced by a taken branch path is promoted, based on the branch decision.

The flow 200 includes using the data that was promoted 210 for a downstream operation. The promoting the data can include storing the data in a cache, in shared storage, in a memory element within the array, and so on. The promoting can include forwarding the data to other compute elements within the array of compute elements. Further embodiments can include using the data that was promoted for a downstream operation. The downstream operation can include an arithmetic or Boolean operation, a matrix operation, a neural network operation, etc. The flow 200 further includes ignoring results 212 from a side of the branch not indicated by the branch decision. Any results, such as data generated by control words associated with the side of the branch not indicated, are unneeded for further processing of a task, subtask, and so on. Rather than having to expend clock cycles, architectural cycles, etc. associated with the array of compute elements to flush, overwrite, delete, the unneeded data, no cycles are expended in ignoring the data. Further, no control words are required to ignore the data. The registers, cache, or other storage associated with the unneeded data can be made available for further processing. Further embodiments can include removing results from a side of the branch not indicated by the branch decision. In the event that leaving data associated with the side of the branch indicated might cause a race condition, data ambiguity, or some other possible processing conflict, then the unneeded data can be removed from storage, registers, a cache, etc.

The flow 200 includes using the promoted data for a committed write 220. A committed write can include writing data into storage that, if occurring before the data is confirmed by the branch decision, can cause storage to be corrupted or invalid for any further operation. A committed write can include an indication of data ready, data valid, data complete, etc. Since which of the sides of the branch will be taken is unknown a priori, then writing data prior to the determination of which side of the branch direction is taken could present a race condition, provide invalid data, and the like. In further embodiments, the branch decision cannot be ignored or reversed, thus strengthening the need to prevent committed writes prior to the point at which the committed write can be invalidated or reversed. Discussed throughout, the committed write can store data in one or more registers, a register file, a cache, storage, etc., which are not local to the compute element that produced it. In embodiments, the committed write can include a committed write to data storage. The data storage can be located within the array of elements, coupled to the array, accessible by the array through a network such as a computer network, etc. In embodiments, the data storage resides outside of the 2D array of compute elements. The flow 200 further includes scheduling a committed write 230, by the compiler, to occur outside a branch indecision window. A branch indecision window can include a number of cycles, architectural cycles, and so on, required to execute control words prior to a branch decision. The branch indecision window can close when the branch decision is determined, the control unit is notified, the data associated with the taken side of the branch is promoted, and the data associated with the untaken side is ignored. In embodiments, the scheduling the committed write can avoid halting operation of the array. The scheduling can be based on cycles, architectural cycles, etc. The scheduling can include a number of cycles associated with the branch indecision window, a number of cycles for promoting data, and the like.

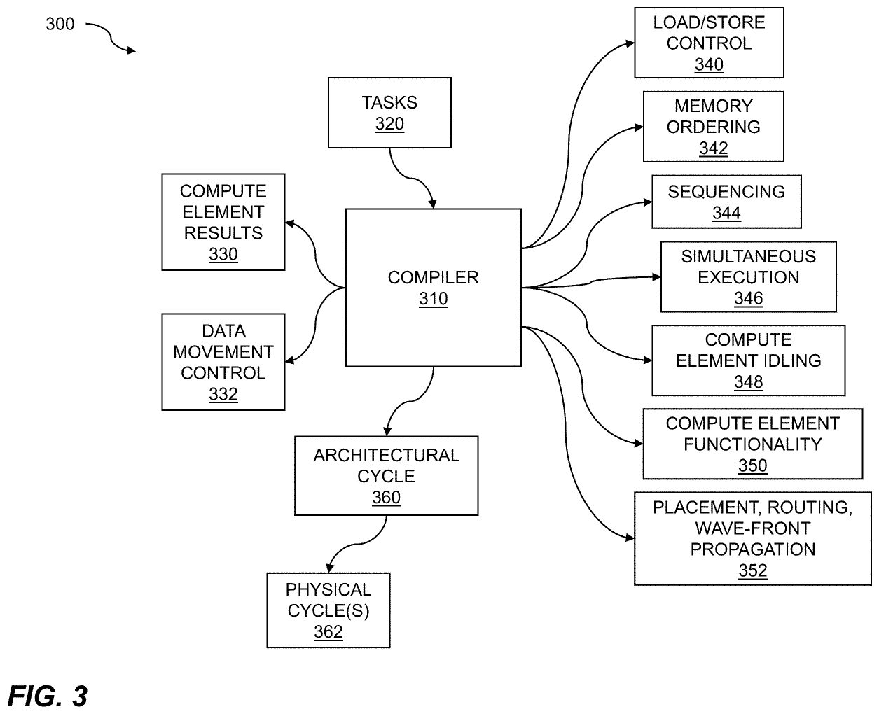

FIG. 3 shows a system block diagram for compiler interactions. Discussed throughout, compute elements within an array are known to a computer which can compile tasks and subtasks for execution on the array. The compiled tasks and subtasks are executed to accomplish task processing. A variety of interactions, such as placement of tasks, routing of data, and so on, can be associated with the compiler. The interactions enable a highly parallel processing architecture using dual branch execution. A two-dimensional (2D) array of compute elements is accessed. Each compute element within the array of compute elements is known to a compiler and is coupled to its neighboring compute elements within the array of compute elements. Control for the array of compute elements is provided on a cycle-by-cycle basis. The control is enabled by a stream of wide, variable length, control words generated by the compiler, wherein the control includes a branch. Two sides of the branch are executed in the array while waiting for a branch decision to be acted upon by control logic. The branch decision is based on computation results in the array. Data produced by a taken branch path is promoted based on the branch decision.

The system block diagram 300 includes a compiler 310. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 320. The tasks can include a plurality of tasks associated with a processing task. The tasks can further include a plurality of subtasks. The tasks can be based on an application such as a video processing or audio processing application. In embodiments, the tasks can be associated with machine learning functionality. The compiler can generate directions for handling compute element results 330. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 332 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and resultant data handling, and so on. The compiler can further generate directions for configuring the compute elements, storage elements, control units, ALUs, and so on, associated with the array. As previously discussed, the compiler generates directions for data handling to support the task handling. In the system block diagram, the data movement can include loads and stores 340 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory access precedence. In the system block diagram, the memory access precedence can enable ordering of memory data 342. Memory data can be ordered based on task data requirements, subtask data requirements, and so on. The memory data ordering can enable parallel execution of tasks and subtasks.

In the system block diagram 300, the ordering of memory data can enable compute element result sequencing 344. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 346 of two or more potential compiled task outcomes based on the set of directions. The code that is compiled by the compiler can include branch points, where the branch points can include computations or flow control. Flow control transfers instruction execution to a different sequence of instructions. Since the result of a branch decision, for example, is not known a priori, then the sequences of instructions associated with the two or more potential task outcomes can be fetched, and each sequence of instructions can begin execution. When the correct result of the branch is determined, then the sequence of instructions associated with the correct branch result continues execution, while the branches not taken can be halted, flushed, ignored, and so on. In embodiments, the two or more potential compiled outcomes can be executed on spatially separate compute elements within the array of compute elements.

The system block diagram includes compute element idling 348. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 350. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 352 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can describe and control how execution of tasks and subtasks proceeds through the array of compute elements.

In the system block diagram, the compiler can control an architectural cycle 360. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. In embodiments, an architectural cycle can occur when a control word is available to be pipelined into the array of compute elements and when all data dependencies are met, That is, the array of compute elements does not have to wait for either dependent data to load or for a full memory queue to clear. In the system block diagram, the architectural cycle can include one or more physical cycles 362. A physical cycle can refer to one or more cycles at the element level required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. In other embodiments, the compiler can provide, via the control word, operand size information for each column of the array of compute elements. The operand size is used to determine how many load operations may be required to obtain data. Various operand sizes can be used. In embodiments, the operand size can include bytes, half-words, words, and double-words.

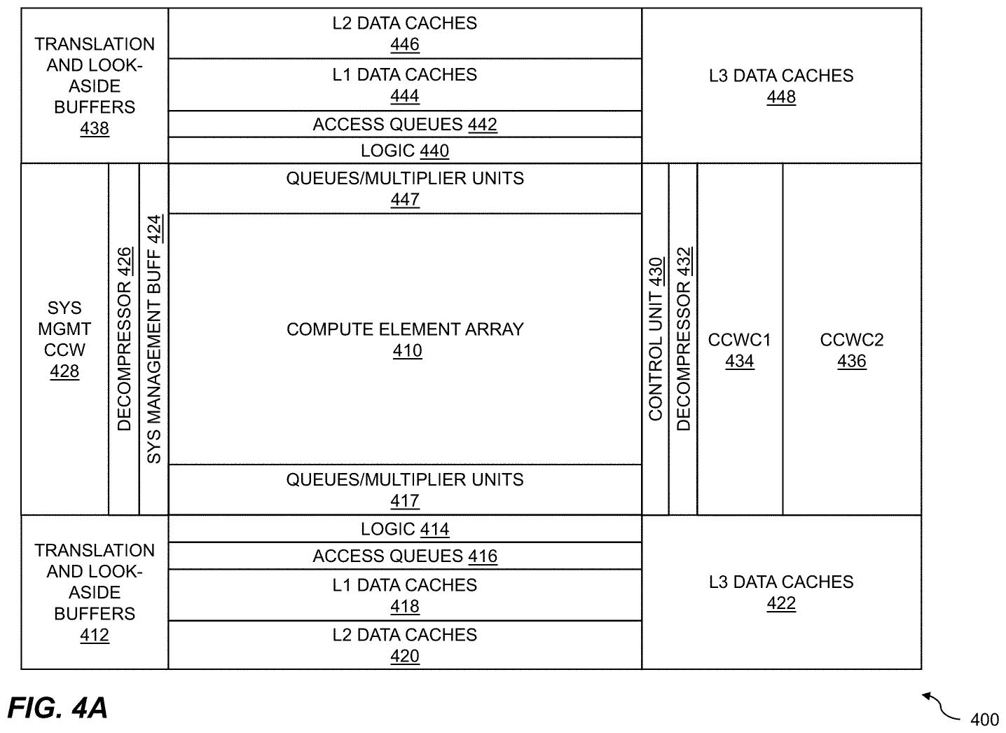

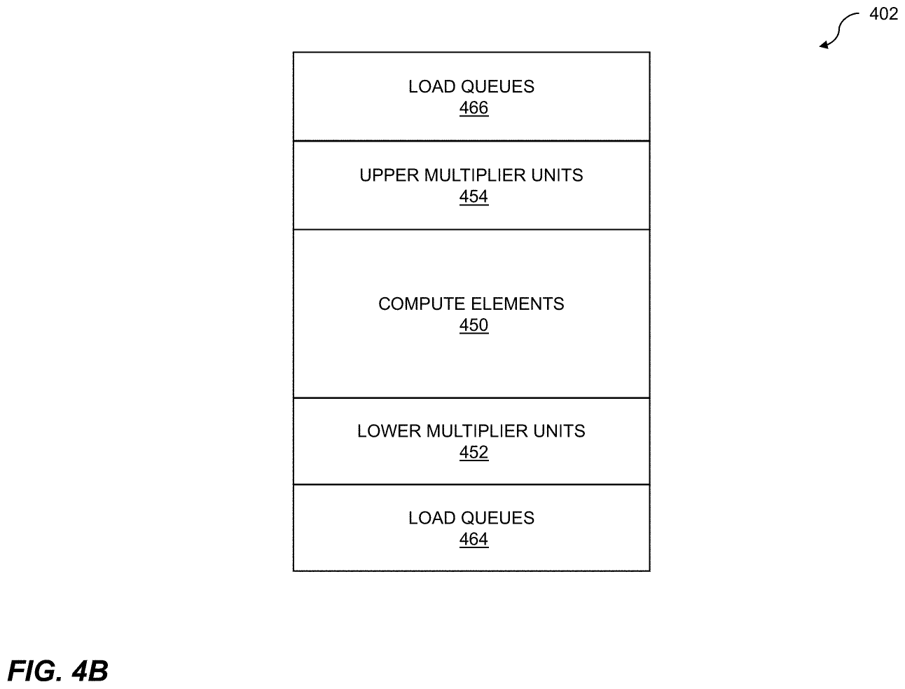

FIG. 4A illustrates a system block diagram for a highly parallel architecture with a shallow pipeline. The highly parallel architecture can comprise components including compute elements, processing elements, buffers, one or more levels of cache storage, system management, arithmetic logic units, multipliers, and so on. The various components can be used to accomplish task processing, where the task processing is associated with program execution, job processing, etc. The task processing is enabled using a parallel processing architecture with distributed register files. A two-dimensional (2D) array of compute elements is accessed, wherein each compute element within the array of compute elements is known to a compiler and is coupled to its neighboring compute elements within the array of compute elements. Directions are provided to the array of compute elements based on control words generated by a compiler. The control words, which can include microcode control words, enable or idle various compute elements; provide data; route results between or among CEs, caches, and storage; and the like. The directions enable compute element operation and memory access precedence. Compute element operation and memory access precedence enable the hardware to properly sequence compute element results. The directions enable execution of a compiled task on the array of compute elements.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers are part of the memory addressing system. The memory caches can be used to reduce storage access times. The system block diagram can include logic for load and access order and selection. The logic for load and access order and selection can include logic 414 and logic 440. Logic 414 and 440 can accomplish load and access order and selection for the lower data block (416, 418, and 420) and the upper data block (442, 444, and 446), respectively. This layout technique can double access bandwidth, reduce interconnect complexity, and so on. Logic 440 can be coupled to the compute element array 410 through the queues and multiplier units 447 component. In the same way, logic 414 can be coupled to compute element array 410 through the queues and multiplier units 417 component.

The system block diagram can include access queues. The access queues can include access queues 416 and 442. The access queues can be used to queue requests to access caches, storage, and so on, for storing data and loading data. The system block diagram can include level 1 (L1) data caches such as L1 caches 418 and 444. The L1 caches can be used to store blocks of data such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L1 and L2 caches and can include slower storage. Accessing data from L3 caches is still faster than accessing main storage. In embodiments, the L1, L2, and L3 caches can include 4-way set associative caches.

The block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the uncompressed control words. The system management CCW component 428 can also include a spill buffer. The spill buffer can comprise a large static random-access memory (SRAM) which can be used to support multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

FIG. 4B shows compute element array detail 402. A compute element array can be coupled to components which enable the compute elements to process one or more tasks, subtasks, and so on. The components can access and provide data, perform specific high-speed operations, and the like. The compute element array and its associated components enable a parallel processing architecture with background loads. The compute element array 450 can perform a variety of processing tasks, where the processing tasks can include operations such as arithmetic, vector, matrix, or tensor operations; audio and video processing operations; neural network operations; etc. The compute elements can be coupled to multiplier units such as lower multiplier units 452 and upper multiplier units 454. The multiplier units can be used to perform high-speed multiplications associated with general processing tasks, multiplications associated with neural networks such as deep learning networks, multiplications associated with vector operations, and the like. The compute elements can be coupled to load queues such as load queues 464 and load queues 466. The load queues can be coupled to the L1 data caches as discussed previously. The load queues can be used to load storage access requests from the compute elements. The load queues can track expected load latencies and can notify a control unit if a load latency exceeds a threshold. Notification of the control unit can be used to signal that a load may not arrive within an expected timeframe. The load queues can further be used to pause the array of compute elements. The load queues can send a pause request to the control unit that will pause the entire array, while individual elements can be idled under control of the control word. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data and control word) can be performed. The memory systems can be free running and can continue to operate while the array is paused. Because multi-cycle latency can occur due to control signal transport, which results in additional “dead time”, it can be beneficial to allow the memory system to “reach into” the array and deliver load data to appropriate scratchpad memories while the array is paused. This mechanism can operate such that the array state is known, as far as the compiler is concerned. When array operation resumes after a pause, new load data will have arrived at a scratchpad, as required for the compiler to maintain the statically scheduled model.

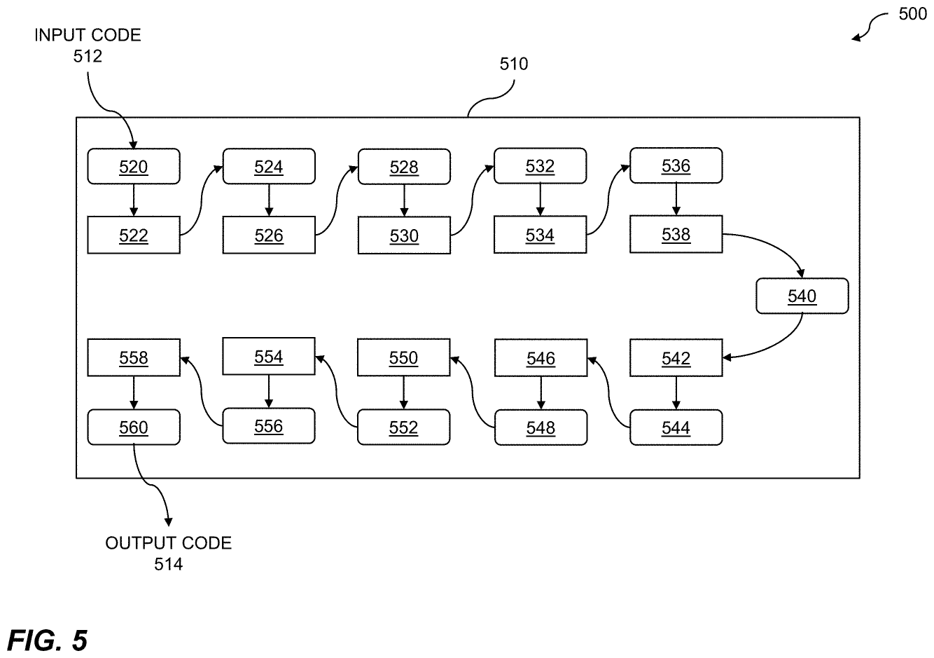

FIG. 5 shows a standard code generation pipeline. Control that is provided to hardware on a cycle-by-cycle basis can include code for task processing. The code can include code written in a high-level language such as C, C++, Python, etc.; in a low-level language such as assembly language; and so on. The code generation pipeline can be used to convert an intermediate code or intermediate representation such as low-level virtual machine (LLVM) intermediate representation (IR) to a target machine code. The target machine code can include machine code that can be executed by one or more compute elements within the array of compute elements. The code generation pipeline enables a highly parallel processing architecture using dual branch execution. An example code generation pipeline 500 is shown. The code generation pipeline can perform one or more operations 510 to convert code such as the LLVM IR code to output code 514. The pipeline can receive input code 512. The received input can include a list in the LLVM IR representation 520. The intermediate form can include single static assignment (SSA) form where each variable associated with the code is assigned only once. The pipeline can include a DAG lowering component 522. The DAG lowering component can reduce the order of the DAG and can output a non-legalized or unconfirmed DAG 524. The non-legalized DAG can be legalized or confirmed using a DAG legalization component 526. The DAG legalization component can output a legalized DAG 528. The legalized DAG can be provided to an instruction selection component 530. The instruction selection component can include generated instructions 532. The generated instructions can be specified directly in control word microcode for one or more compute elements of the array of compute elements. The native instructions, which can represent processing tasks and subtasks, can be scheduled using a scheduling component 534. The scheduling component can be used to generate a list where the list includes code in a static single assignment (SSA) 536 form of an intermediate representation (IR). The SSA form can include a single assignment of each variable, where the assignment occurs before the variable is referenced or used within the code. An optimizer component 538 can optimize the code in SSA form. The optimizer can generate optimized code in SSA form 540.

The optimized code in SSA form can be processed using a register allocation component 542. The register allocation component can generate a list of physical registers 544, where the physical registers can include registers or other storage within the array of compute elements. The code generation pipeline can include a post allocation component 546. The post allocation component can be used to resolve register allocation conflicts, to optimize register allocations, and the like. The post allocation component can include a list of physical registers 548. The pipeline can include a prologue and an epilogue component 550. The prologue and epilogue component can add code associated with a prologue and code associated with an epilogue. The prologue can include code that can prepare the registers, and so on, for use. The epilogue can include code to reverse the operations performed by the prologue when the code between the prologue and the epilogue has been executed. The prologue and epilogue component can generate a list of resolved stack reservations 552. The pipeline can include a peephole optimization component 554. The peephole optimization component can be used to optimize a small sequence of code or a “peephole” to improve performance of the small sequence of code. The output of the peephole optimizer component can include an optimized list of resolved stack reservations 556. The pipeline can include an assembly printing component 558. The assembly printing component can generate assembly language text of the assembly code 560. The output of the standard code generation pipeline can include output code 514 for inclusion in a stream of wide, variable length control words.

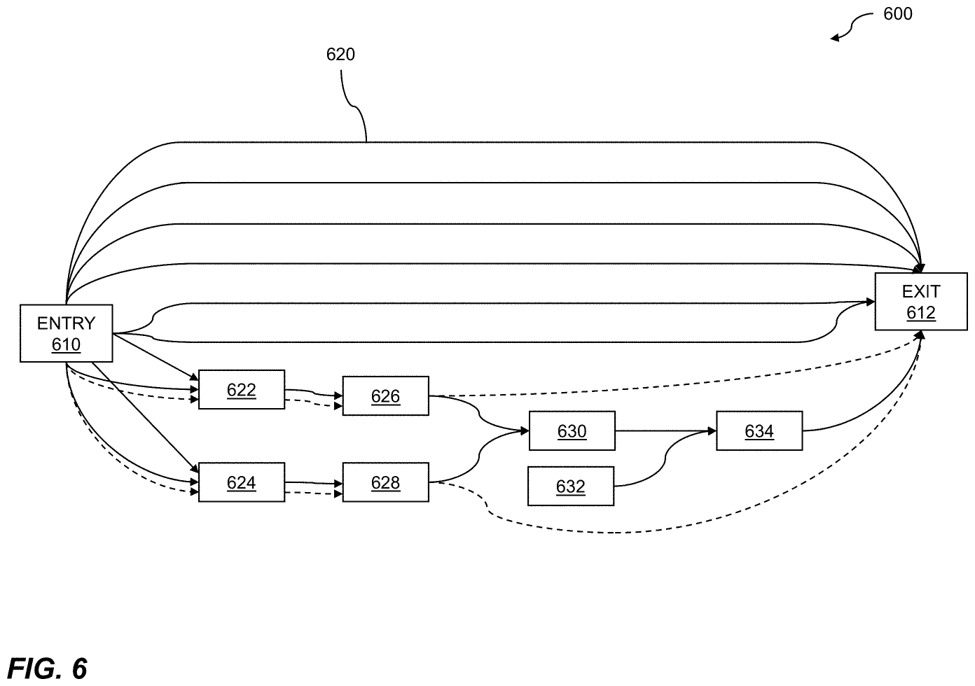

FIG. 6 illustrates translating directions to a directed acyclic graph (DAG) of operations. The processing of tasks and subtasks on an array of compute elements can be modeled using a directed acyclic graph. The DAG shows dependencies between and among the tasks and subtasks. The dependencies can include task and subtask precedence, priorities, and the like. The dependencies can also indicate an order of execution and a flow of data to, from, and among the tasks and subtasks. Translating instructions to a DAG enables a highly parallel processing architecture using dual branch execution. A two-dimensional (2D) array of compute elements is accessed. Each compute element within the array is known to a compiler and is coupled to its neighboring compute elements. Control for the array of compute elements is provided on a cycle-by-cycle basis. Two sides of the branch are executed in the array while waiting for a branch decision to be acted upon by control logic. The branch decision is based on computation results in the array. Data produced by a taken branch path is promoted based on the branch decision.

A set of directions, which can include code, instructions, microcode, and so on, can be translated to DAG operations 600. The instructions can include low level virtual machine (LLVM) instructions. Given code, such as code that describes directions discussed previously and throughout, a DAG can be generated. The DAG can include information about placement of tasks and subtasks, but does not necessarily include information about the scheduling of the tasks and subtasks and the routing of data to, from, and among the tasks. The graph includes an entry 610 or input, where the entry can represent an input port, a register, an address in storage, etc. The entry can be coupled to an output or exit 612. The exit point of the DAG can be reached by completing tasks and subtasks of the DAG. In the event of an exception such as an error, missing data, a storage access conflict, etc., then the DAG can halt or exit with an error. The entry and the exit of the DAG can be coupled by one or more arcs 620, where each arc can include one or more processing steps. The processing steps can be associated with the tasks, subtasks, and so on. An example sequence of processing steps, based on the directions, is shown. The sequence of processing steps can include various instructions 622 and 624. The instructions can involve a double precision (e.g., 64-bit) value. The sequence can include other instructions, such as instructions 626 and 628. The sequence can include yet another instruction 630. The sequence can include a further instruction 632. The sequence can include a yet a further instruction 634. On completion of the last instruction in the sequence of instructions, flow within the DAG proceeds to the exit of the graph 612.

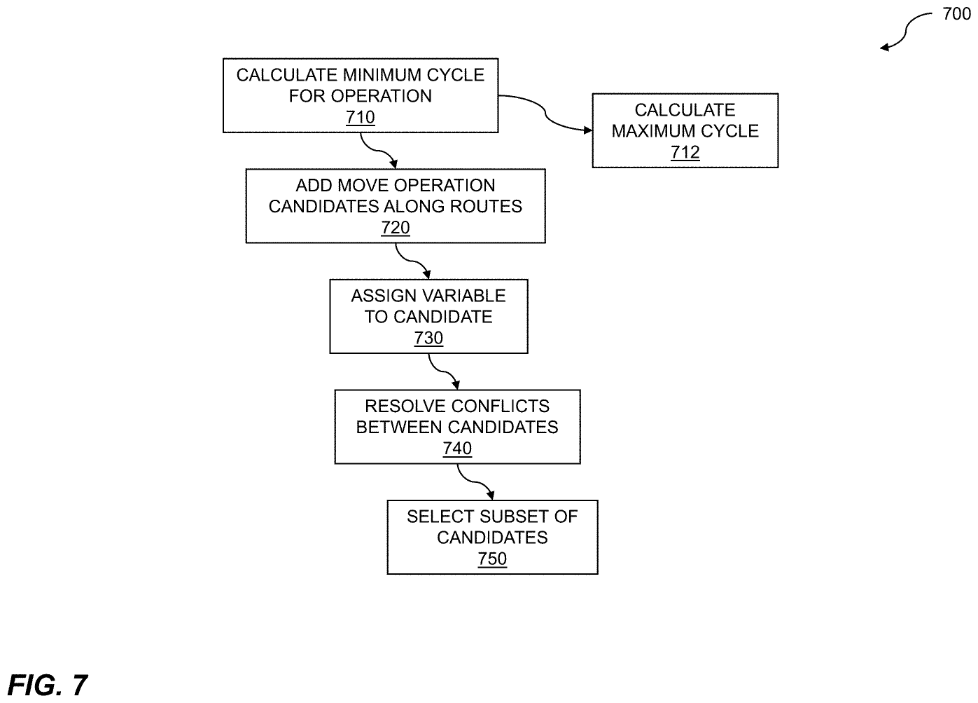

FIG. 7 is a flow diagram for creating a SAT model. Task processing, which comprises processing tasks, subtasks, and so on, includes performing one or more operations associated with the tasks. The operations can include arithmetic operations; Boolean operations; vector, array, or matrix operations; tensor operations; and so on. In order for tasks, subtasks and the like to be processed correctly, the controls such as control words, directions, etc., that are provided to hardware such as the compute elements within the 2D array, must indicate when the operations are to be performed and how to route data to and from the operations. A satisfiability or SAT model can be created for ordering tasks, operations, etc., and for providing data to and from the compute elements. Creating a satisfiability model enables a highly parallel processing architecture using dual branch execution. Each operation associated with a task, subtask, and so on, can be assigned a clock cycle, where the clock cycle can be relative to a clock cycle associated with the start of a block of instructions. One or more move (MV) operations can be inserted between an output of an operation and inputs to one or more further operations.

The flow 700 includes calculating a minimum cycle 710 for an operation. The minimum cycle can include the earliest cycle during which an operation can be performed. The cycle can include a physical cycle such as a local, module, subsystem, or system clock; an architectural clock; and so on. The minimum cycle can be determined by traversing a directed acyclic graph (DAG) in topological order. The traversing can be used to calculate a distance between an output of the DAG and an input. Data can flow from, to, or between compute elements without conflicting with other data. In embodiments, the set of directions can control the array of compute elements on a physical cycle-by-cycle basis. A physical cycle can enable an operation, can transfer data, and so on. In embodiments, the cycle-by-cycle basis can be enabled by a stream of wide, variable length, microcode control words generated by the compiler. The microcode control words can enable elements such as compute elements, arithmetic logic units (ALUs), memories or other storage, etc. In other embodiments, the physical cycle-by-cycle basis can include an architectural cycle. A physical cycle can differ from an architectural cycle in that a physical cycle can orchestrate a given operation or set of operations on one or more compute element or other elements. An architectural cycle can include a cycle of an architecture, where the architecture can include compute elements, ALUs, memories, and so on. An architectural cycle can include one or more physical cycles. The flow 700 includes calculating a maximum cycle 712. The maximum cycle can include the latest cycle during which an operation can be performed. If the minimum cycle equals the maximum cycle for a given operation, then that operation continues on a critical path of the DAG.

The flow 700 includes adding move operation candidates 720 along different routes from an output to an input. The move operation candidates can include possible placements of operations or “candidates” to compute elements and other elements within the array. The candidates can be based on directions generated by the compiler. In embodiments, the set of directions can include a spatial allocation of subtasks on one or more compute elements within the array of compute elements. The spatial allocation can ensure that operations do not interfere with one another with respect to resource allocation, data transfers, etc. A subset of the operation candidates can be chosen such that the resulting program, that is, the code generated by the complier, is correct. The correct code successfully accomplishes the processing of the tasks. The flow 700 includes assigning a Boolean variable to each candidate 730. If the Boolean variable is true, then the candidate is included. If the Boolean variable is false, then the candidate is not included. By imposing logical constraints between or among the Boolean variables, a correct program can be achieved. The logical constraints can include performing an operation only once such that all inputs can be satisfied, one or more ALUs have a unique configuration, the candidates cannot move different values into the same register, and the candidates cannot set control word bits to conflicting values.

The flow 700 includes resolving conflicts 740 between candidates. Conflicts can occur between candidates, where the conflicts can include violations of one or more constraints listed above, resource contention, data conflicts, and so on. Simple conflicts between candidates can be formulated using conjunctive normal form (CNF) clauses. The constraints based on the CNF clauses can be evaluated using a solver such as an operations research (OR) solver. The flow 700 includes selecting a subset 750 of candidates. Discussed above, the subset of candidates can be selected such that the resulting “program”, that is the sequencing of operations, subtasks, tasks, etc., is correct. In the sense of a program, “correctness” refers to the ability of the program to meet a specification. A program is correct if for each input, the expected output is produced. The program can be compiled by the compiler to generate a set of directions for the array. Not all elements of the array may be required for implementing the set of directions. In embodiments, the set of directions can idle an unneeded compute element within a row of compute elements located in the array of compute elements.

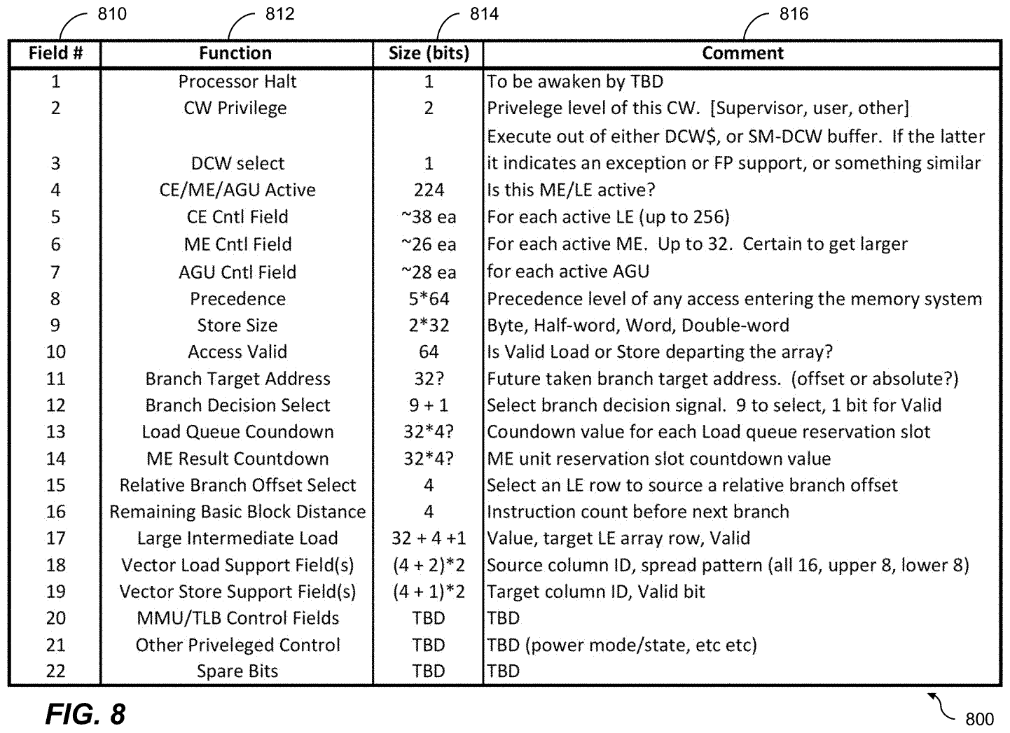

FIG. 8 is a table showing example decompressed control word fields. Discussed throughout, control can be provided to an array of compute elements on a cycle-by-cycle basis. The control of the array is enabled by a stream of microcode control words, where the microcode control words can be generated by a compiler. The microcode control word, which comprises a plurality of fields, can be stored in a compressed format to reduce storage requirements. The compressed control word can be decompressed in order to enable control of one or more compute elements within the array of compute elements. The fields of the decompressed control word enable a highly parallel processing architecture using dual branch execution. A two-dimensional (2D) array of compute elements is accessed, wherein each compute element within the array of compute elements is known to a compiler and is coupled to its neighboring compute elements within the array of compute elements. Control for the array of compute elements is provided on a cycle-by-cycle basis, wherein the control is enabled by a stream of wide, variable length, control words generated by the compiler. The control includes a branch. Data produced by a taken branch path is promoted, based on the branch decision.

A table 800 showing control word fields for a decompressed control word is shown. The decompressed control word comprises fields 810. While 22 fields are shown, other numbers of fields can be included in the decompressed control word. The number of fields can be based on a number of compute elements within an array, processing capabilities of the compute elements, compiler capabilities, requirements of processing tasks, and so on. Each field within the decompressed control word can be assigned a purpose or function 812. The function of a field can include providing, controlling, etc., commands, data, addresses, and so on. In embodiments, the one or more fields within the decompressed control word can include spare bits. Each field within the decompressed control word can include a size 814. The size can be based on a number of bits, nibbles, bytes, and the like. Comments 816 can also be associated with fields within the decompressed control word. The comments further explain the purpose, function, etc., of a given field.

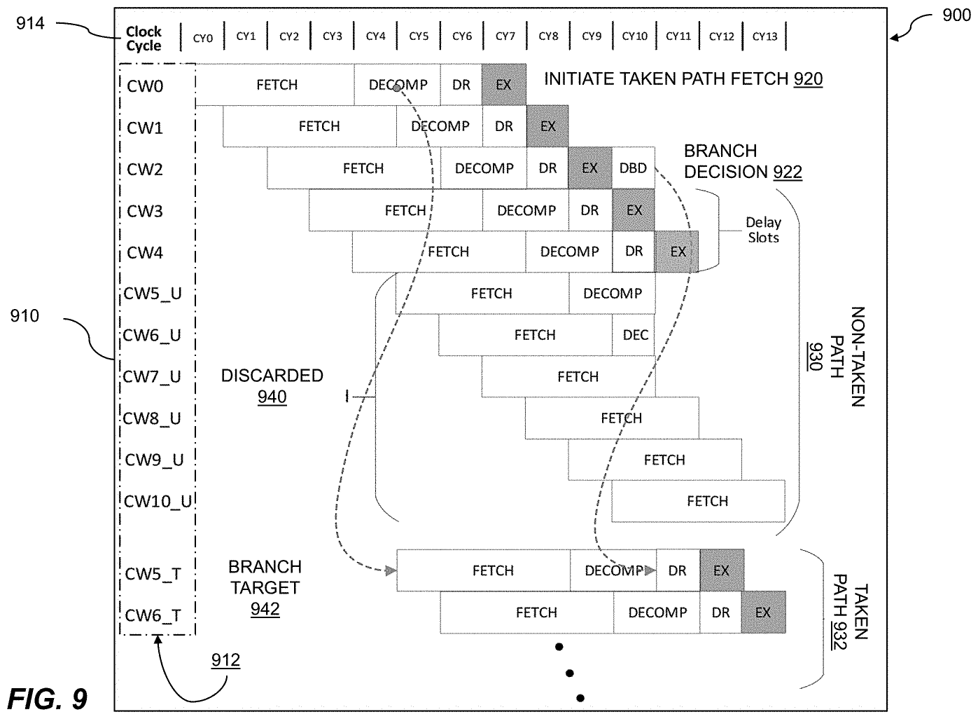

FIG. 9 shows a taken branch based on compiler guidance 900. Discussed throughout, two sides of a branch can be executed based on control provided for an array of compute elements. The control is enabled by a stream of wide, variable length, control words generated by a compiler. The plurality of operations associated with the control can include a branch. In order to improve processing performance of the array of compute elements, instructions or operations associated with each of the branch paths can be fetched, and execution of the instructions or operations associated with both the branch paths can be performed. Each branch path can produce data prior to a branch decision being acted upon by control logic. Once a branch decision has been made by the control logic, the data associated with the taken branch path can be promoted, while the data associated with the untaken branch path can be ignored. The taken branch determined from compiler guidance is based on a highly parallel processing architecture using dual branch execution. A two-dimensional (2D) array of compute elements is accessed. Control for the array of compute elements is provided on a cycle-by-cycle basis. Two sides of the branch in the array are executed while waiting for a branch decision to be acted upon by control logic. Data produced by a taken branch path is promoted, based on the branch decision. Results from a side of the branch not indicated by the branch decision are ignored.

An example of executing each side of a branch is shown 910. The execution of each side of the branch is based on control words 912 (control words are highlighted in a dashed-line box). The control words can be provided by a compiler, where the compiler can generate the control words by compiling one or more tasks, subtasks, and so on for execution on an array of compute elements. The execution of the control words can be based on cycles 914, where the control words can be provided on a cycle-by-cycle basis. The control words can include compressed control words. The control words can be stored in compressed or uncompressed formats within a cache associated with the array of compute elements. Each control can be fetched (designated “fetch” in the figure) from the cache or from storage. The fetched control word can be decompressed (decomp) when the control word is stored in compressed format prior to distribution (dr) into the array. The control word can be executed (ex) when it has been distributed within the array.

The fetches of control words can include fetching an initiate taken path fetch 920 control word. The initiate taken path control word can be decompressed if necessary, distributed, and executed. As the initiate taken path control word is being processed, additional control words can be fetched and processed. In embodiments, the fetching and processing can be accomplished using a pipeline technique. Among the additional control words that are fetched can be the control words associated with the two branch paths shown. The control words associated with each branch path can be fetched, decompressed, distributed, and executed. The executing can produce data. A branch decision 922 can be acted upon by control logic. When the branch decision is made, then one of the branch paths can be determined to be a non-taken path 930, while the other branch path can be determined to be the taken branch path 932. The non-taken path can be ignored or discarded 940 since the control words that were fetched and any data that was generated is unneeded. Embodiments can include ignoring results from a side of the branch not indicated by the branch decision. The ignored data, which may have been placed in a cache, storage, and so on, can simply be left there. When another operation is performed and data is produced, the produced data can be stored in the locations of the previously ignored data. Other embodiments can include removing results from a side of the branch not indicated by the branch decision. The taken path 932 comprises the branch target 942. Data associated with the branch target can be promoted. Promoting the data can include storing the data in a cache, shared storage, a memory, and so on. The promoting can include forwarding the data to other compute elements within the array of compute elements. Further embodiments can include using the data that was promoted for a downstream operation. The downstream operation can include an arithmetic or Boolean operation, a matrix operation, a neural network operation, etc.

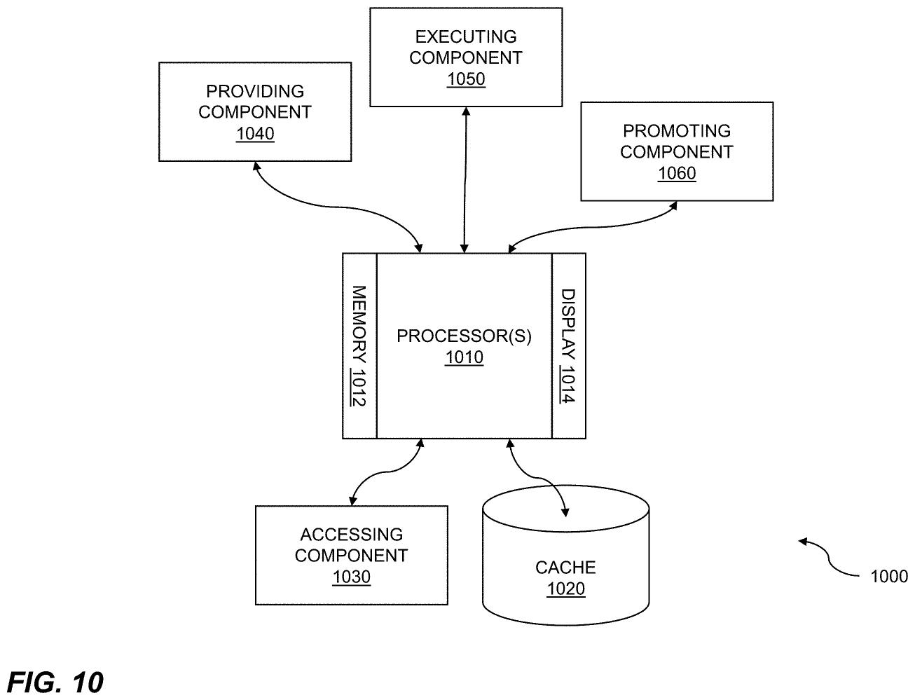

FIG. 10 is a system diagram for task processing. The task processing is performed in a highly parallel processing architecture, where the highly parallel processing architecture uses dual branch execution. The system 1000 can include one or more processors 1010, which are attached to a memory 1012 which stores instructions. The system 1000 can further include a display 1014 coupled to the one or more processors 1010 for displaying data; intermediate steps; directions; control words; control words implementing Very Long Instruction Word (VLIW) functionality; topologies including systolic, vector, cyclic, spatial, streaming, or VLIW topologies; and so on. In embodiments, one or more processors 1010 are coupled to the memory 1012, wherein the one or more processors, when executing the instructions which are stored, are configured to: access a two-dimensional (2D) array of compute elements, wherein each compute element within the array of compute elements is known to a compiler and is coupled to its neighboring compute elements within the array of compute elements; provide control for the array of compute elements on a cycle-by-cycle basis, wherein the control is enabled by a stream of wide, variable length, control words generated by the compiler, and wherein the control includes a branch; execute two sides of the branch in the array while waiting for a branch decision to be acted upon by control logic, wherein the branch decision is based on computation results in the array; and promote data produced by a taken branch path, based on the branch decision. Embodiments include using the data that was promoted for a downstream operation. The downstream operation can include an arithmetic or Boolean operation, a matrix operation, and so on. The taken branch path can continue execution and can generate further data. The untaken branch path can be handled differently. Embodiments include ignoring results from a side of the branch not indicated by the branch decision. The results from the branch not taken can be deleted, overwritten, and so on. Further embodiments include removing results from a side of the branch not indicated by the branch decision. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 1000 can include a cache 1020. The cache 1020 can be used to store data such as data associated with the sides of the branch, directions, control words, intermediate results, microcode, and so on. The cache can comprise a small, local, easily accessible memory available to one or more compute elements. In embodiments, the data that is stored can include data associated with the sides of the branch. Discussed throughout, data associated with one side of the branch can be promoted for a downstream operation, while data associated with the other side or sides of the branch can be ignored. Embodiments include storing relevant portions of a direction or a control word within the cache associated with the array of compute elements. The cache can be accessible to one or more compute elements. The cache, if present, can include a dual read, single write (2R1 W) cache. That is, the 2R1 W cache can enable two read operations and one write operation contemporaneously without the read and write operations interfering with one another. The system 1000 can include an accessing component 1030. The accessing component 1030 can include control logic and functions for accessing a two-dimensional (2D) array of compute elements, wherein each compute element within the array of compute elements is known to a compiler and is coupled to its neighboring compute elements within the array of compute elements. A compute element can include one or more processors, processor cores, processor macros, and so on. Each compute element can include an amount of local storage. The local storage may be accessible to one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX). Discussed below, two or more sides of a branch can be executed while waiting for a branch decision. The branch decision can be based on code conditionality, where the conditionality can be established by a control unit. Code conditionality can include a branch point, a decision point, a condition, and so on. In embodiments, the conditionality can determine code jumps. A code jump can change code execution from sequential execution of control words to execution of a different set of control words. The conditionality can be established by a control unit. In a usage example, a 2R1 W cache can support simultaneous fetch of potential branch paths for the control unit. Since the branch path taken by a direction or control word containing a branch can be data dependent, and is therefore not known a priori, then control words associated with more than one branch path can be fetched prior to execution (prefetch) of the branch control word. As discussed elsewhere, an initial part of the two or more branch paths can be instantiated in a succession of control words. When the correct branch path is determined, the computations associated with the untaken branch can be flushed and/or ignored.

The system 1000 can include a providing component 1040. The providing component 1040 can include control and functions for providing control for the array of compute elements on a cycle-by-cycle basis, wherein the control is enabled by a stream of wide, variable length, control words generated by the compiler, and wherein the control includes a branch. The control of the array of compute elements on a cycle-by-cycle basis can include configuring the array to perform various compute operations. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, a Multiple Instruction Multiple Data (MIMD), or a Very Long Instruction Word (VLIW) topology. Other topologies can include a neural network topology. A control word can enable machine learning functionality for the neural network topology.

The system 1000 can include an executing component 1050. The executing component 1050 can include control logic and functions for executing two sides of the branch in the array while waiting for a branch decision to be acted upon by control logic, wherein the branch decision is based on computation results in the array. The computations that can be performed can include arithmetic operations, Boolean operations, matrix operations, neural network operations, and the like. The computations can be executed on the control words generated by the compiler. The control words can be provided to a control unit where the control unit can control the operations of the compute elements within the array of compute elements. Operation of the compute elements can include configuring the compute elements, providing data to the compute elements, routing and ordering results from the compute elements, and so on. In embodiments, the same control word can be executed on a given cycle across the array of compute elements. The executing can include decompressing the control words. The control words can be decompressed on a per compute element basis, where each control word can be comprised of a plurality of compute element control groups or bunches. One or more control words can be stored in a compressed format within a memory such as a cache. The compression of the control words can reduce storage requirements, complexity of decoding components, and so on. In embodiments, the control unit can operate on decompressed control words. The two sides of the branch can represent a decision point such as true or false, a condition met or not met, an evaluation, etc. The execution of the two sides of the branch can include obtaining data, operating on data, storing data, and so on. The execution of the two sides of the branch can continue until the branch decision is acted upon by control logic. A branch can comprise more than two sides. In embodiments, the execution can be performed on the more than two sides until a decision is made by the control logic.

The branch decision can be part of a compiled task, which can be one of many tasks associated with a processing job. The compiled task can be executed on one or more compute elements within the array of compute elements. In embodiments, the executing of the compiled task can be distributed across compute elements in order to parallelize the execution. The executing the compiled task can include executing the tasks for processing multiple datasets (e.g., single instruction multiple data or SIMD execution). Embodiments can include providing simultaneous execution of two or more potential compiled task outcomes. Recall that the provided control word or words can control code conditionality for the array of compute elements. In embodiments, the two or more potential compiled task outcomes comprise a computation result or a flow control. The code conditionality, which can be based on computing a condition such as a value, a Boolean equation, and so on, can cause execution of one of two or more sequences of instructions, based on the condition. In embodiments, the two or more potential compiled outcomes can be controlled by a same control word. In other embodiments, the conditionality can determine code jumps. The two or more potential compiled task outcomes can be based on one or more branch paths, data, etc. The executing can be based on one or more directions or control words. Since the potential compiled task outcomes are not known a priori to the evaluation of the condition, the set of directions can enable simultaneous execution of two or more potential compiled task outcomes. When the condition is evaluated, then execution of the set of directions that is associated with the condition can continue, while the set of directions not associated with the condition (e.g., the path not taken) can be halted, flushed, and so on. In embodiments, the same direction or control word can be executed on a given cycle across the array of compute elements. The executing tasks can be performed by compute elements located throughout the array of compute elements. In embodiments, the two or more potential compiled outcomes can be executed on spatially separate compute elements within the array of compute elements. Using spatially separate compute elements can enable reduced storage, bus, and network contention; reduced power dissipation by the compute elements; etc. Whatever the basis for the conditionality, the conditionality can be established by a control unit.

The system 1000 can include a promoting component 1060. The promoting component 1060 can include control logic and functions for promoting data produced by a taken branch path, based on the branch decision. A branch decision is determined by a compute element in the array, and then control unit logic can determine what action to take based on the branch decision, for example, the data associated with the taken branch path can be promoted. The taken branch path data can be promoted by performing a committed write operation. In embodiments, the committed write can include a committed write to data storage. The data storage can include a cache, local storage elements associated with the array of elements, storage coupled to the array of elements, and the like. The committed write operation can be scheduled. Further embodiments can include scheduling a committed write, by the compiler, to occur outside a branch indecision window. The branch indecision window can include an amount of time, a number of cycles, etc., that can elapse from the time of the branch decision in the array until the time the branch decision can be acted upon by a control unit, which can potentially change the flow of control through the application of different decompressed control words to the array. In other embodiments, the data that was promoted is used for a downstream operation. The downstream operation can include an operation performed on the same compute element, on another compute element, on a plurality of compute elements, and the like. Further embodiments include ignoring results from a side of the branch not indicated by the branch decision. Data resulting from operations performed by the branch not taken are by definition unneeded so simply can be ignored. Any further operations associated with the branch do not need to be executed. In some embodiments, results from a side of the branch not indicated by the branch decision can be removed. The removing can be accomplished by flushing the data, overwriting the data, and so on.

The system 1000 can include a computer program product embodied in a non-transitory computer readable medium for task processing, the computer program product comprising code which causes one or more processors to perform operations of: accessing a two-dimensional (2D) array of compute elements, wherein each compute element within the array of compute elements is known to a compiler and is coupled to its neighboring compute elements within the array of compute elements; providing control for the array of compute elements on a cycle-by-cycle basis, wherein the control is enabled by a stream of wide, variable length, control words generated by the compiler, and wherein the control includes a branch; executing two sides of the branch in the array while waiting for a branch decision to be acted upon by control logic, wherein the branch decision is based on computation results in the array; and promoting data produced by a taken branch path, based on the branch decision.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for task processing comprising:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide, variable length, control words generated by the compiler, and wherein the control includes a branch;
executing two sides of the branch in the array while waiting for a branch decision to be acted upon by control logic, wherein the branch decision is based on computation results in the array; and
promoting data produced by a taken branch path, based on the branch decision.

2. The method of claim 1 further comprising using the data that was promoted for a downstream operation.

3. The method of claim 2 further comprising ignoring results from a side of the branch not indicated by the branch decision.

4. The method of claim 2 further comprising removing results from a side of the branch not indicated by the branch decision.

5. The method of claim 1 wherein the data produced by a taken branch path is used for a committed write.

6. The method of claim 5 wherein the committed write cannot be ignored or reversed.

7. The method of claim 5 wherein the committed write includes a committed write to data storage.

8. The method of claim 7 wherein the data storage resides outside of the 2D array of compute elements.

9. The method of claim 1 further comprising scheduling, by the compiler, a committed write for the data produced by a taken branch path to occur outside of a branch indecision window.

10. The method of claim 9 wherein the scheduling the committed write avoids halting operation of the array.

11. The method of claim 1 wherein the executing obviates branch prediction logic.

12. The method of claim 1 further comprising loading the data produced by a taken branch path into in-array compute element memory.

13. The method of claim 12 further comprising ignoring data that was loaded into the in-array compute element memory, based on the branch decision.

14. The method of claim 1 further comprising executing an additional branch concurrently with the two sides of a branch.

15. The method of claim 14 wherein the additional branch and the two sides of a branch comprise a multiway branch evaluation.

16. The method of claim 14 wherein the additional branch and the two sides of a branch comprise two independent branch decisions.

17. The method of claim 1 further comprising using row ring buses to provide branch address offsets to the array of compute elements.

18. The method of claim 1 wherein the branch decision is communicated using a carry out bit of array Arithmetic Logic Units (ALUs).

19. The method of claim 1 further comprising storing portions of a control word, from the stream of control words, within a cache associated with the array of compute elements.

20. The method of claim 19 wherein the cache comprises a dual read, single write (2R1 W) data cache.

21. The method of claim 20 wherein the 2R1 W cache supports simultaneous fetch of potential branch paths for a control unit.

22. The method of claim 1 wherein the compiler maps machine learning functionality to the array of compute elements.

23. The method of claim 22 wherein the machine learning functionality includes a neural network implementation.

24. The method of claim 1 further comprising stacking the 2D array of compute elements with another 2D array of compute elements to form a three-dimensional stack of compute elements.

25. A computer program product embodied in a non-transitory computer readable medium for task processing, the computer program product comprising code which causes one or more processors to perform operations of:
accessing a two-dimensional (2D) array of compute elements, wherein each compute element within the array of compute elements is known to a compiler and is coupled to its neighboring compute elements within the array of compute elements;
providing control for the array of compute elements on a cycle-by-cycle basis, wherein the control is enabled by a stream of wide, variable length, control words generated by the compiler, and wherein the control includes a branch;
executing two sides of the branch in the array while waiting for a branch decision to be acted upon by control logic, wherein the branch decision is based on computation results in the array; and
promoting data produced by a taken branch path, based on the branch decision.

26. A computer system for task processing comprising:
a memory which stores instructions;
one or more processors coupled to the memory, wherein the one or more processors, when executing the instructions which are stored, are configured to:
access a two-dimensional (2D) array of compute elements, wherein each compute element within the array of compute elements is known to a compiler and is coupled to its neighboring compute elements within the array of compute elements;
provide control for the array of compute elements on a cycle-by-cycle basis, wherein the control is enabled by a stream of wide, variable length, control words generated by the compiler, and wherein the control includes a branch;
execute two sides of the branch in the array while waiting for a branch decision to be acted upon by control logic, wherein the branch decision is based on computation results in the array; and
promote data produced by a taken branch path, based on the branch decision.
